(19) United States
(12) Patent Application Publication
(10) Pub. No.: US 2019/0290080 A1
(43) Pub. Date: Sep. 26, 2019

(54) Suction or Blower Device

(71) Applicant: Positec Power Tools (Suzhou) Co., Ltd., Suzhou (CN)

(72) Inventors: Jiabo Liu, Suzhou (CN); Xuefeng Yu, Suzhou (CN); Shisong Zhang, Suzhou (CN); Xiahong Dai, Suzhou (CN); Mingxiang Wang, Suzhou (CN); Jinhua Liu, Suzhou (CN); Feng Shen, Suzhou (CN); Qimeng An, Suzhou (CN)

(21) Appl. No.: 16/271,221

(22) Filed: Feb. 8, 2019

Related U.S. Application Data
(63) Continuation of application No. 14/031,823, filed on Sep. 19, 2013, now abandoned.

(30) Foreign Application Priority Data
Jun. 26, 2013 (CN) 201310259521.4
Jun. 26, 2013 (CN) 201310260023.1
Jun. 26, 2013 (CN) 201310261409.4
Sep. 4, 2013 (CN) 201310397878.9

(51) Int. Cl. A47L 5/14; A47L 9/24; A47L 5/22; B08B 5/04; B08B 5/02; B08B 1/00; A47L 9/32; A47L 5/24; A47L 9/02; A47L 9/00

(52) U.S. Cl. CPC A47L 5/14; A47L 9/242; A47L 5/225; B08B 5/04; B08B 5/02; B05B 1/005; A47L 9/322; A47L 5/24; A47L 9/02; A47L 9/0027; Y10T 29/49826; B08B 1/002

(57) ABSTRACT

The present invention relates to a blower vacuum device having a housing with an air inlet and an air outlet, a motor accommodated in the housing, a fan driven by the motor, and a plurality of blowing accessories adapted to be connected to the air outlet respectively when the suction or blower device works. These different blowing accessories can perform various cleaning functions, thus meeting the cleaning demands in different places or in a specific area.

### BACKGROUND

The present invention relates to a suction or blower device (also commonly known as a blower vac). A blower vac (or a vacuum and blower) is usually comprised of a housing having an air inlet and an air outlet, a motor accommodated in the housing, and a fan driven by the motor. The blower forms a directional airflow always incoming from the air inlet and flowing out from the air outlet through the rotating fan. Through the directional airflow, the blower achieves the good effect of blowing dust (or collecting fallen leaves) and is favoured as a necessary outdoor gardening tool by more and more families.

However, the current blowers (or the vacuum and blowers) only have a few functions. Aside from the removal of dust and collection of fallen leaves, the current blowers (or the vacuum and blowers) almost have no other functions. Even if for blowing dust and collecting the fallen leaves, they are limited in application, applied only to open gardens and paths outdoor. To clean high places such as gutters and windows or to clean indoor furnishings such as couches and desks, users are required to employ other professional tools which would occupy a lot of space and cause a heavy economical burden to users.

Nowadays, functional diversification has become the scientific development trend.

Combining various different functions with one platform is the major research and development goal of technicians in various fields. The housing of every blower (or vacuum and blower) as a platform for supplying directional airflow theoretically has the ability of delivering diversified functions, but no such technology appears at present. To meet the trend of functional diversification, and more importantly to meet users' demands on low cost and diversified functions, improvements on the existing blowers (or vacuum and blowers) are necessary.

### SUMMARY

A technical problem to be solved by the present invention is to present a suction or blower device. This device should have a range of functions with the price of a single suction or blower tool to fully meet the users' demands of indoor and outdoor house cleaning.

To solve the said technical problem, the present invention adopts the following technical scheme: A suction or blower device, comprising a housing having an air inlet and an air outlet, a motor accommodated in the housing, a fan driven by the motor, and a plurality of blowing accessories adapted to be connected to the air outlet respectively.

The present invention has the following beneficial effects: different blowing accessories adapted to be connected to the air outlet, respectively, can provide different cleaning functions, thus meeting the cleaning demands in different directions or in a specific area.

Preferably, the blowing accessories comprises at least three in a group of a blower tube extending longitudinally, an elbow brush having a blower nozzle with bristles and the blower nozzle being angular to the air outlet, a flat brush having a narrow outlet extending perpendicularly to the air outlet, and a gutter cleaning pipe having a straight pipe and an elbow pipe connected to the straight pipe. Among the various blowing accessories mentioned above, the whole suction or blower device is light and exquisite after the blower tube is mounted on the whole suction or blower device, so that users can easily and lightly blow the dust away from the higher surface. Meanwhile, the blower tube avoids airflow loss caused by the normal long tube, thus the blowing efficiency is higher. The elbow brush has a relatively large-sized end, capable of blowing and cleaning places such as corners and window bars where dust gathers easily. The flat brush narrows and concentrates the air coming from the narrow outlet, capable of blowing down water beads and water membranes on the water-accumulating planes such as mirrors and glass windows. The straight pipe of the gutter cleaning pipe is used to guide the airflow into the elbow pipe. The elbow pipe is set to adapt to eaves to guide the blowing airflow to the gutter of the eave and facilitate cleaning fallen leaves. All in all, each of the above four blowing accessories can be independently adapted to an application site. The housing of the suction or blower device of the present invention is joined to at least three of the above accessories, so that the suction or blower device has at least three functions.

Preferably, the blower tube having a blowing opening, a ratio of a sectional area of the air outlet to a sectional area of the blowing opening is between 4˜500.

Preferably, the blower tube comprises a short tube with a blowing opening, a ratio of a sectional area of the air outlet to a sectional area of the blowing opening is between 4˜20, the short tube having a length no more than 200 mm.

Preferably, the short tube having a big end and a small end, the blowing opening is formed on the small end, the big end is adapted to be connected to the air outlet directly. The air blown by the suction or blower device is accelerated and boosted through the tapered small end before flowing out of the short tube, thus improving the blowing efficiency and facilitating removal of some target substances with large masses.

Preferably, wherein the blower tube further comprises at least one of a first nozzle and a second nozzle, the first nozzle having a first blower opening and the second nozzle having a second blower opening, a ratio of a sectional area of the air outlet to a sectional area of the first blowing opening is between 20˜100, a ratio of a sectional area of the air outlet to a sectional area of the second blowing opening is between 100˜500.

Preferably, the first nozzle comprises a first joint end and a first free end, the first blowing opening is formed on the first free end, the first joint end is detachably connected to the small end.

Preferably, the blowing accessories further comprise a flexible tube assembly having a flexible tube with two flexible jointed ends formed thereon respectively, the flexible tube assembly is detachably connected to the small end.

Preferably, the first nozzle comprises a first joint end and a first free end, the first blowing opening is formed on the first free end, the second nozzle comprises a second joint end and a second free end, the second blowing opening is formed on the second free end, the second joint end is adapt to be connected on the first free end. The second nozzle is detachably connected to the first nozzle, thus saving manufacturing cost to a certain extent.

Preferably, a diameter of the first free end is 10 mm˜20 mm and a diameter of the second free end is 3 mm˜10 mm. The two nozzles different in size are capable of inflating large inflatable devices such as an air bed and small inflation toys such as a swim ring, thus expanding the application scope of inflation.

Preferably, the blowing accessories further comprise a flexible tube assembly having a flexible tube with two flexible jointed ends formed thereon respectively, the flexible tube assembly is detachably connected between the small end and the first jointed end, the second nozzle comprises a second joint end and a second free end, the second blowing opening is formed on the second free end, the second joint end is adapt to be connected on the first free end.

Preferably, the blower tube further comprises a bristle head mounted around the circumference of the blowing opening, the bristle head extending along the same direction as a longitudinal extending direction of the blower tube. With the bristle head, the blower tube can blow air with a high speed and sweep the dust accumulated in small gaps, especially in some instrument panels with its bristle head.

Preferably, the elbow brush comprises a jointed end being configured to be connected with the air outlet and a fixed end being configured to be angularly bent and communicated to the jointed end, the bristles mounted around the circumference of the fixed end and extending along the same direction as a longitudinal extending direction of the fixed end. The fixed end forms an angle relative to the jointed end, improving the accessibility of the elbow brush and bringing convenience to users to hold the suction or blower device at a comfortable angle and easily clean places that are hard to reach.

Preferably, the bristles have a certain length of no more than 40 mm. The bristles shall be of an appropriate length, thus facilitating dust removal in a relatively large area on one hand with the full use of the blowing air on the other hand to prevent a weakening of the blowing effect due to the long bristles.

Preferably, the flat brush comprises an air inlet nozzle extending longitudinally and an air outlet nozzle being angular to the air inlet nozzle, the narrow outlet is formed on a free end of the air outlet nozzle. The air outlet nozzle that forms an obtuse angle relative to the air inlet nozzle can smoothly guide the direction of the air to reduce air loss, on one hand, and to strengthen the accessibility of the flat brush to improve the comfort of operating the flat brush, on the other hand.

Preferably, the air outlet nozzle comprises a first pad and a second pad opposite the first pad, the first pad and the second pad both have a piece of rubber fixed thereon respectively. The rubber makes the cleaning of smooth surfaces easier and more convenient and can prevent scratching the object surface.

Preferably, the gutter cleaning pipe is 360° rotatably connected to the air outlet.

Preferably, the blowing accessories further comprise a middle pipe having one end detachably connected to the air outlet and another end being 360° rotatably connected to the straight pipe. The middle pipe provides an angled convenience to the adjustment of the elbow pipe and connects to the air outlet, close to the position where the user holds the suction or blower device to facilitate rotation.

Preferably, a bump arranged on one of the middle pipe and the straight pipe, an axial guiding groove together with a circumferential groove arranged on the other of the middle pipe and the straight pipe, the bump is guided to enter and slide in the circumferential groove through the axial guiding groove. The adaptation structure of the straight pipe and the middle pipe is simple to operate, low in manufacturing cost and convenient to use.

Preferably, the bump has an interference fit against the circumferential groove. The bump and the circumferential groove are more tightly joined through the interference fit and do not rotate relative to each other out of control.

Preferably, the straight pipe comprises a set of small pipes coupled to one another through a threaded fit. The straight pipe adopts a segmented design. On one hand, the storage space and transportation cost are reduced. On the other hand, the user can select the number of straight pipes according to his height and the height of the gutter to flexibly adjust the height of the gutter cleaning pipe. In addition, a threaded connection is reliable and easily molded.

Preferably, each small pipe has a coupling portion supporting at least two heads of thread. The design of a multi-headed thread can shorten the rotation circles of the straight pipes and improve assembling efficiency.

Preferably, the straight pipe having reinforcing ribs longitudinally extending on an outer surface of the straight pipe. No matter if the single pipe type or the segment type is used, the straight pipe needs to support the elbow pipe, and the air impacts to a certain degree when passing through the straight pipe, so that it is necessary to reinforce the straight pipe. The reinforcing ribs on the outer surface of the straight pipe not only improves the strength of the straight pipe, but also serves as an anti-skid device to facilitate holding.

Preferably, the elbow pipe is configured as a U shape comprising a first portion connected to the straight pipe, a second portion acting as a free end and a middle portion joined the first portion and the second portion together, forming an angle 100°˜115° between the first portion and the middle portion, and an angle 115°˜120° between the middle portion and the second portion. The shape of the elbow pipe can reduce the energy loss of the air when flowing to the maximum extent and makes the elbow pipe easily reach the gutter of the eave, so that gutter cleaning can be done with only half the effort.

Preferably, the second portion has an extended length between 85 mm and 100 mm. The second portion with a proper length of the elbow pipe can more closely reach the gutter of the eave to improve the gutter cleaning effect.

Preferably, at least one of the blowing accessories is connected to the air outlet through a coupling unit. The coupling unit at least comprises a joint conduit with one end coupled to the air outlet and the other end connected to one of the blowing accessories. Some of the blowing accessories can be directly coupled to the air outlet while some need coupling through the joint conduit. One joint conduit can provide coupling for many accessories, thus saving costs and also expanding the application scope of the joint conduit itself.

Preferably, the coupling unit further comprises a flexible tube assembly detachably connected between the joint conduit and one of the blowing accessories. The flexible tube assembly connected between the joint conduit and the selected one of the blowing accessories strengthens its accessibility, expanding the application scope and facilitating operation.

Preferably, the suction or blower device further comprises a deflating accessory detachably connected to the air inlet, the deflating assembly having a deflating funnel detachably connected to the air inlet and a deflating nozzle connected with the deflating funnel.

Preferably, the air inlet having an inlet grill, the deflating funnel having a big opening and a small opening, the big opening of the deflating funnel communicating with the inlet grill and the small opening communicating with the deflating nozzle with a free end diameter of 3 mm˜20 mm. The air inlet is connected to the deflating nozzle with such a small inner diameter, so that the suction or blower device can further execute the deflating operation through the oriented airflow generated by the suction or blower device. Without dismantling the air inlet grill, the deflating funnel is installed through the air inlet grill, thus simplifying the installation process.

Preferably, the blowing accessories further comprise a flexible tube assembly releasably connected between the deflating funnel and the deflating nozzle. Through this flexible tube assembly, the working zone of the deflating nozzle is expanded and the accessibility of the suction or blower device is improved.

Preferably, the suction or blower device is powered by a battery connected to the housing. The battery-powered suction or blower device is flexible and not limited to the length of the power cord and position of the sockets and can be conveniently used at various sites.

Preferably, the battery is a rechargeable battery, such as, for example, a lithium type battery. The lithium battery is light and highly efficient, making the suction or blower device also light, convenient and easily operated.

Another technical problem to be solved by the present invention is to present a method for setting a deflating accessory to a suction or blower device through simple operations.

To solve the said technical problem, the present invention adopts the following technical scheme:

A method for setting a deflating accessory to a suction or blower device, the suction or blower device comprising a housing having an air inlet and an air outlet, a motor accommodated in the housing, a fan driven by the motor, an inlet grill for fixing to the air inlet, a deflating assembly releasably attached to the air inlet, the method comprising: setting the deflating accessory to the inlet grill directly.

The present invention has the following beneficial effects: it's convenient for the user to install the deflating accessory directly to the suction or blower device through only one step of process, without the operation of taking off the inlet grill.

Preferably, the inlet grill comprises a plurality of grids with interval between, the deflating accessory having a plurality of spring claws, the spring claws engaged with the grids when the deflating accessory being attached to the inlet grill.

### BRIEF DESCRIPTION OF THE DRAWINGS

The above and other objects, features and advantages of the invention will become more apparent from the following description of embodiments in conjunction with the accompanying drawings in which:

FIG. 1 is a schematic view of the housing of the blower in a preferred configuration of the present invention.

FIG. 2 is a schematic view of combination of the housing and the normal blower tube of the blower as shown in FIG. 1.

FIG. 3a is a schematic view of the gutter cleaning pipe in a preferred configuration of the present invention.

FIG. 3b is a schematic view of the short tube in a preferred configuration of the present invention.

FIG. 3c is a schematic view of the elbow brush in a preferred configuration of the present invention.

FIG. 3d is a schematic view of the flat brush in a preferred configuration of the present invention.

FIG. 3e is a schematic view of the inflating accessory in a preferred configuration of the present invention.

FIG. 3f is a schematic view of the second brush in a preferred configuration of the present invention.

FIG. 4 is a schematic view of the housing of the blower as shown in FIG. 1 connecting the short tube.

FIG. 5 is a schematic view of the housing of the blower as shown in FIG. 1 connecting the gutter cleaning pipe 1.

FIG. 6 is a connection relation view of gutter cleaning pipe as shown in FIG. 5.

FIG. 7 is a schematic view of the housing of the blower as shown in FIG. 1 connecting the elbow brush assembly.

FIG. 8 is a schematic view of the housing of the blower as shown in FIG. 1 connecting the flat brush.

FIG. 9 is a schematic view of the housing of the blower as shown in FIG. 1 connecting the inflating accessory.

FIG. 10 is an exploded view of the inflating accessory as shown in FIG. 9.

FIG. 11 is a schematic view of the housing of the blower as shown in FIG. 1 connecting a second brush assembly.

FIG. 12 is an exploded view of the second brush accessory as shown in FIG. 11.

FIG. 13 is a schematic view of the clamp.

FIG. 14 is a schematic view of the housing of the blower as shown in FIG. 1 connecting the deflating accessory.

FIG. 15 is an exploded view of the deflating accessory as shown in FIG. 14.

| | | |
|---|---|---|
| 9 housing | 91 switch | 92 operating handle |
| 93 battery | 94 air inlet | 95 air outlet |
| 950 elastic button | 96 air inlet grill | 960 grid |
| 10 orifice | 2 short tube | 21 big end |
| 22 small end | 1 gutter cleaning pipe | 11 middle pipe |
| 110 bump | 12 straight pipe | 120 circumferential |
| 128 reinforcing rib | 13 elbow pipe | groove |
| | | 131 first portion |
| 132 second portion | 133 middle portion | 3 elbow brush |
| 31 bend tube | 311 jointed end | 312 fixed end |
| 32 bristles | 4 flat brush | 41 air inlet nozzle |
| 42 air outlet nozzle | 421 narrow outlet | 422 rubber |
| 5 inflating accessory | 51 first nozzle | 511 first jointed end |
| 512 first free end | 52 second nozzle | 521 second jointed end |
| 522 second free end | 53flexible tube | 531 flexible tube |
| | assembly | 61 second brush |
| 532 flexible joint end | 6 second brush | |
| | accessory | 7 deflating accessory |
| 611 short nozzle | 612 bristle head | |
| 71 deflating funnel | 711 big opening | 712 small opening |
| 713 pushing block | 8 clamp | 81 first opening |
| 82 second opening | 100 blower | 98 normal blower tube |

### DETAILED DESCRIPTION

The present invention shows a suction or blower device. In this embodiment, the suction or blower device is a battery type blower 100 and the battery is a lithium battery, so that the suction or blower device is light and convenient. Of course, the device may also be used as a vacuum and blower with both blowing and dust collection functions. The suction or blower device not only can be powered by the battery, but also by alternating current or a gasoline engine.

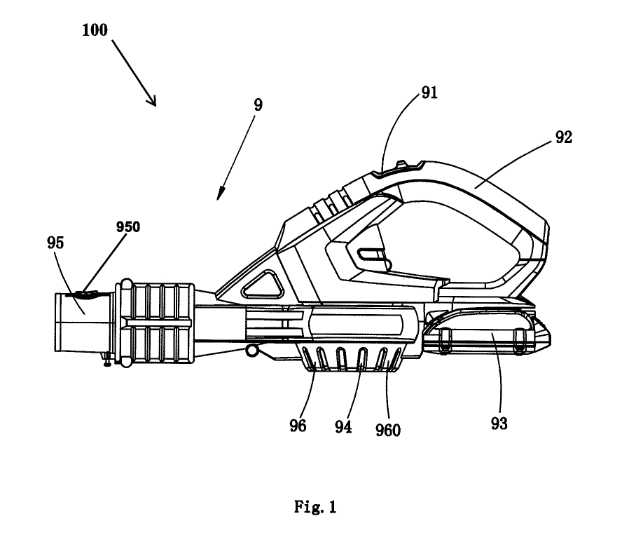

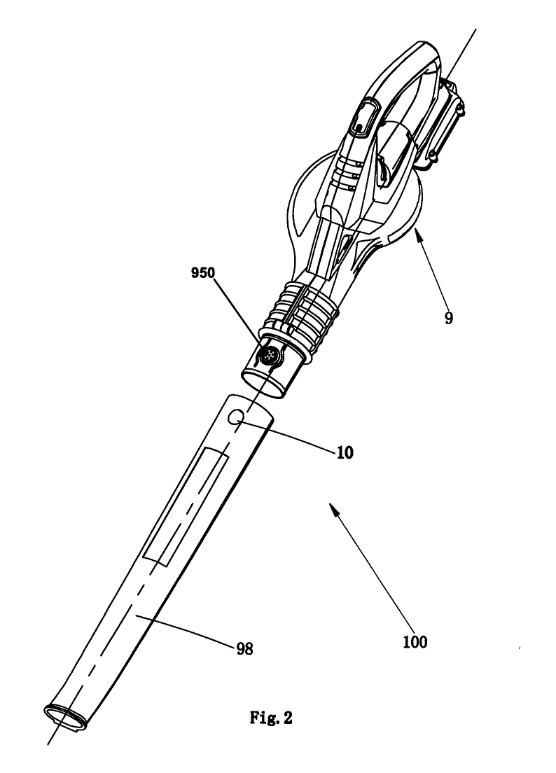

As shown in FIG. 1 and FIG. 2, the blower 100 comprises a housing 9 with an operating handle 92, an air inlet 94 and an air outlet 95, a motor (not shown in the figure) accommodated in the housing 9 and a fan (not shown in the figure). A battery 93 is mounted below the operating handle 92. The operating handle 92 is provided with a switch 91 for control startup and stop of the motor. The fan is driven by the motor to rotate at a high speed and generate a negative pressure after the switch 91 is turned on, so that the air quickly enters the air inlet 94 and flows out from the air outlet 95. The air inlet 94 and the air outlet 95 may be respectively connected to the corresponding suction or blowing accessories. For example in this case, the air inlet 94 of the blower 100 is connected to an air inlet grill 96, while the air outlet 95 may be connected to a normal blower 100 tube 98 to have the blowing function. Of course, in other circumstances, the air inlet 94 is connected to a vacuum pipe while the air outlet 95 is connected to a dust collection bag. In this way, the blower 100 has the dust collection function. To sum up, the air always enters from the air inlet 94 and flows out from the air outlet 95 when the blower 100 is working. Users can elect to install different suction or blowing accessories in different cases.

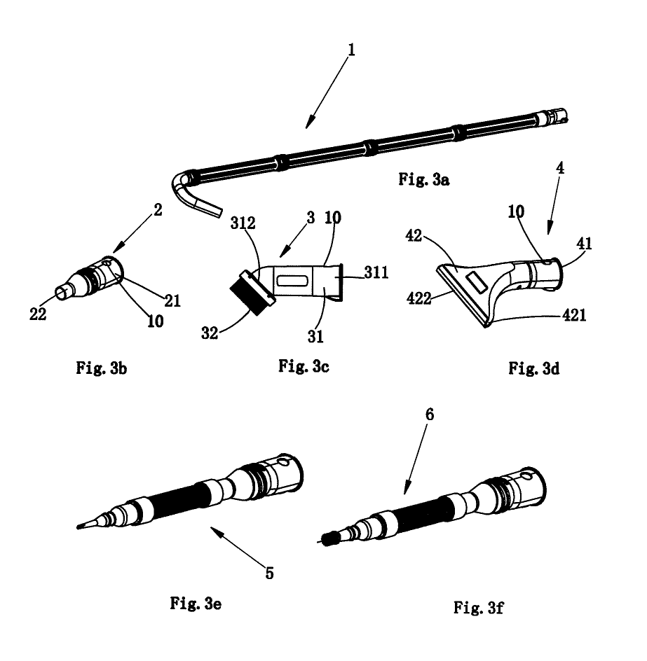

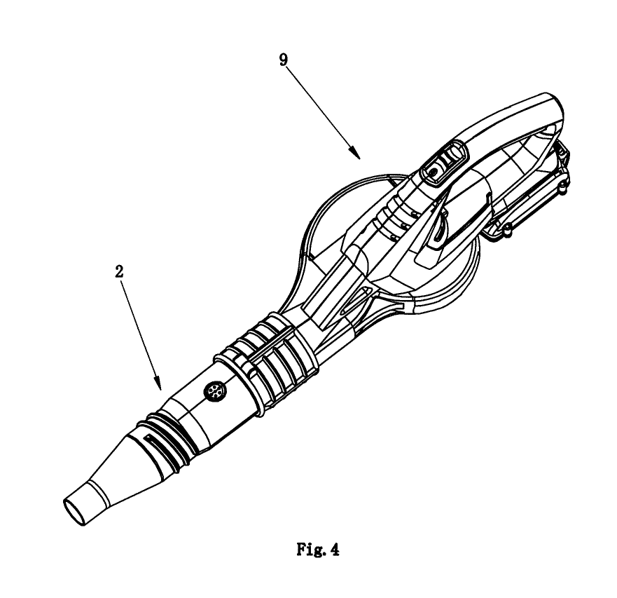

To increase the functions of the blower 100 and ensure that the blower 100 can clean all places in the house, the present invention provides a range of blowing accessories which may be connected to the air outlet 95. As shown in FIGS. 3a to 3f, the blowing accessories comprise a short tube 2, a gutter cleaning pipe 1, an elbow brush 3, a flat brush 4, an inflating accessory 5 and a second brush accessory 6. Different blowing accessories are adapted to different application environments. In one working environment, the blower 100 is adapted to be connected to a corresponding blowing accessory. The following is a detailed description of the combinations of various blowing accessories and the blower 100.

As shown in FIG. 3b and FIG. 4, the short tube 2 extends longitudinally. The short tube 2 comprises a big end 21 detachably connected to the air outlet 95 and a small end 22 away from the air outlet 95. The cross section and size of the big end 21 are approximately equivalent to those of the air outlet 95 so as to be connected to the air outlet 95 through friction fit or other method. The blowing opening is formed on the small end 22, and a ratio of a sectional area of the air outlet 95 to a sectional area of the small end 22 is between 4˜20. Due to the variations of the cross section, the air is suddenly boosted and obviously accelerated in the process of flowing from the air outlet 95 to the small end 22 of the short tube 2. In this embodiment, the short tube 2 is relatively short, no more than 200 mm. It is short and convenient so that users do not have to raise their arms when blowing away hair from the couch, fallen leaves on the balcony, or sawdust on the wood worktable, thus avoiding fatigue caused by the common blower pipe. Due to its short character, the variation in cross section from the air outlet 95 to the small end 22 becomes more obvious, the air loss is further reduced, so that the air blown out is more powerful and can conveniently clean higher tabletops, for example.

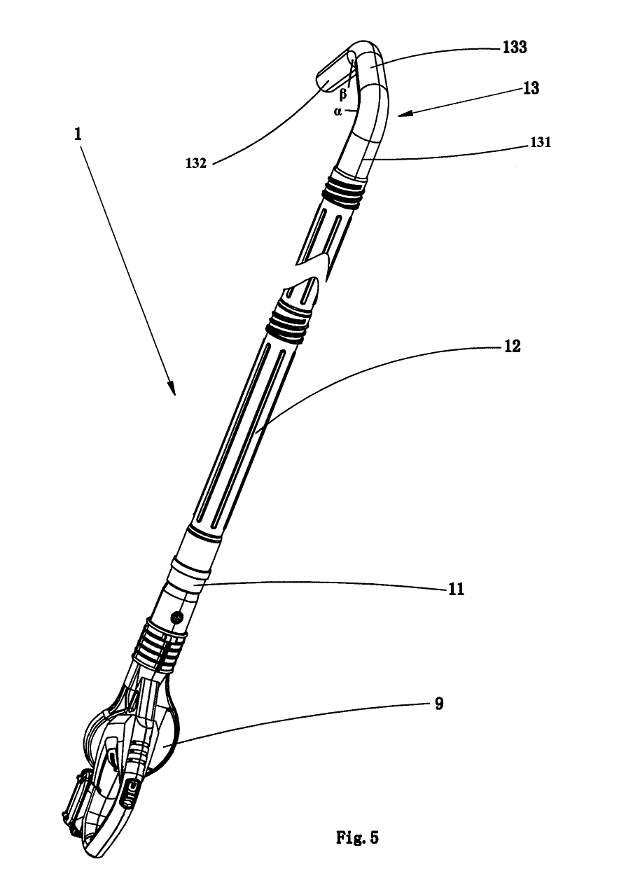

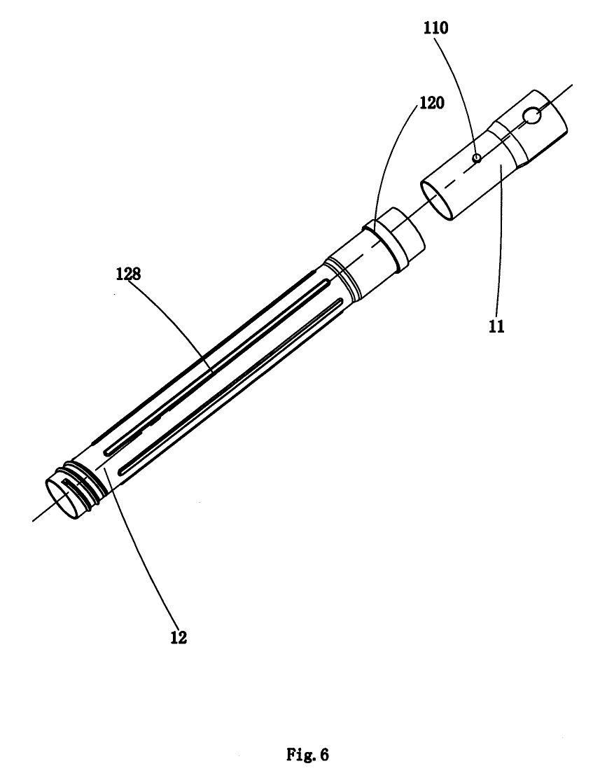

As shown in FIG. 3a and FIG. 5, the blowing accessories comprise the gutter cleaning pipe 1 primarily used for cleaning fallen leaves and dust from the high eave. The total length of the gutter cleaning pipe 1 is no less than 1,500 mm, comprising a longitudinal straight pipe 12 and an elbow pipe 13 connected to the free end of the straight pipe 12. The other end of the straight pipe 12 away from the free end is detachably connected to the air outlet 95 of the blower 100. The elbow pipe 13 can deeply go into the gutter of the eave so as to clean fallen leaves accumulated in it through the airflow.

The straight pipe 12 is formed by a series of connected small pipes 12 so as to save space during transportation and storage. The small pipes 12 are coupled to one another through a threaded fit, namely the inner threads are fitted into the outer threads, so that the connection is firm. Each small pipe has a coupling portion supporting at least two heads of thread, so that the coupling between the small pipes 12 is quicker and more convenient. Of course, the number of the heads of thread may be 3 or 4, or may just be one. Of course, the small pipes 12 may be connected in other ways, such as an interference fit or fit between bumps and grooves. Those skilled in the art can figure out many other configurations, so that detailed examples are omitted here. Longitudinal reinforcing ribs 128 are mounted on the outer surface of the straight pipe 12 to strengthen the straight pipe 12 and prevent damage due to poor strength, on one hand, and serve as an anti-skid device and facilitate connection of the small pipes 12 on the other hand.

As shown in FIG. 5, the elbow pipe 13 is configured as a U shape comprising a first portion 131 connected to the straight pipe. A second portion 132 acting as a free end of the elbow pipe, and a middle portion 133 joining the first portion 131 and the second portion 132 together, forming an angle α between the first portion 131 and the middle portion 133 and an angle β between the middle portion 133 and the second portion 132. To reduce energy loss of the air in the elbow pipe 13 to the largest extent, the angle α and angle β, respectively, have a certain range. In this embodiment, 100°≤α≤115° and 115°≤β≤120°. The second portion 132 of the elbow pipe 13 has an extending length. To make the elbow pipe 13 closer to the gutter of the eave and achieve the optimum cleaning effect, the length in this embodiment is 85 mm˜100 mm.

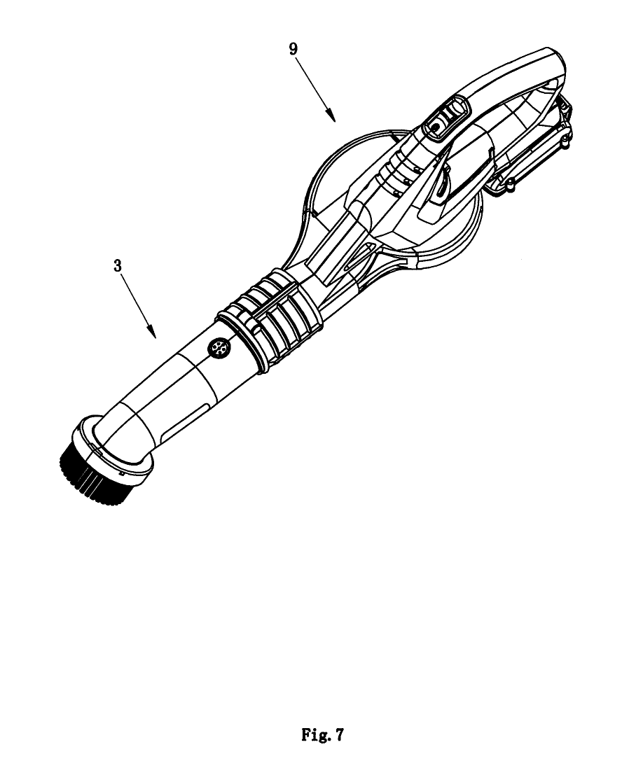

There is a relatively long distance from the free end of the elbow pipe 13 to the blower 100 held by the user, so that it may be inconvenient for the user to adjust the angle of the elbow pipe 13, causing lower efficiency because of moving around. As shown in FIG. 5 and FIG. 6, to solve the above mentioned problem, the blowing accessories in this embodiment further comprise a middle pipe 11 located between the straight pipe 12 and the air outlet 95 of the blower 100. Through the middle pipe 11, the straight pipe 12 circumferentially rotates relative to the air outlet 95, so the elbow pipe 13 can rotate 360° around the axis of the straight pipe 12. The dead corners of the gutter can be cleaned conveniently. A coupling structure is mounted between the middle pipe 11 and the straight pipe 12, facilitating the circumferential rotation of the middle pipe 11 relative to the straight pipe 12. In this embodiment, the coupling structure comprises a bump 110 arranged on the middle pipe 11 and an axial guiding groove (not shown in the figure) together with a circumferential groove 120 arranged on the straight pipe 12. When installing the middle pipe 11 and the straight pipe 12, the bump 110 of the middle pipe 11 aligns with the axial guiding groove on the straight pipe 12, so that the axial movement between the middle pipe 11 and the straight pipe 12 is limited; but the bump 110 can slide in the groove, so that the straight pipe 12 can rotate 360° circumferentially relative to the middle pipe 11. Of course, the rotation of the straight pipe 12 relative to the middle pipe 11 is allowed only when the angle of the elbow pipe 13 needs to be adjusted. To prevent random rotation of the straight pipe 12, the bump 110 has an interference fit with the circumferential groove 120. Of course, damping can be formed between the bump 110 and the circumferential groove 120 in other ways, so that detailed description is omitted here. In addition, the positions of the bump 110 and the axial guiding groove as well as the circumferential groove 120 may be exchanged. Namely the bump 110 can be arranged on the straight pipe 12, while the middle pipe 11 is provided with the axial guiding groove and the circumferential groove 120 matched with the bump 110 in dimension, so that the straight pipe 12 can also circumferentially rotate relative to the middle pipe 11 to meet the needs of changing the direction of the elbow pipe 13.

Those skilled in the art can easily figure out other embodiments to have a rotary connection between the straight pipe 12 and the middle pipe 11, so examples are omitted here. Of course, the middle pipe 11 is not a must, the gutter cleaning pipe 1 can also circumferentially rotate relative to the air outlet 95, if only the rotatable coupling structure is mounted between the straight pipe 12 and the air outlet 95.

As shown in FIG. 3c and FIG. 7, the blowing accessories comprise an elbow brush 3 comprising a bent tube 31 and bristles 32 mounted on the bent tube 31. The bent tube 31 comprises a jointed end 311 being configured to be connected with the air outlet 95 of the blower 100 and a fixed end 312 being configured to be angularly bent and communicated to jointed end 311. The angle between the fixed end 312 and the jointed end 311 is more than 90° but less than 180°. In this embodiment, the end section of the fixed end 312 is round and the end has an inner diameter of 55 mm˜80 mm. Of course, the cross section of the fixed end 312 is not limited to be round as it may also be oval, triangle, quadrangle or other polygons. The bristles 32 are mounted around the fixed end 312, and extend in the same direction with the fixed end 312. In this embodiment, the bristles 32 are fixed on an annular mounting block (not shown) first, and then the mounting block is embedded in the annular groove (not shown) at the circumference of the fixed end 312. In this way, the bristles 32 can be detached independently for washing and cleaning. Of course, the bristles can also be directly transplanted at the circumference of the fixed end 312 of the bent tube 31 as long as the process is allowed, or quickly and effectively mounted on the bend tube 31 by other methods, detailed description is omitted here. The bristles 32 have a certain length. In this embodiment, the length of the bristles 32 does not exceed 40 mm, ensuring that the blown air has a certain speed and pressure in a contact range of the bristles 32. The elbow brush 3 is directly fixed at the air outlet 95 through the jointed end 311, so the blower 100 can remove dust and spider webs from window lattices and corners, and wipe picture posters, etc. on the wall when blowing air. The dust is blown and swept away instantly by the air, thus improving the cleaning efficiency.

In this embodiment, the elbow brush 3 is directly connected to the air outlet 95, so that the user can easily reach dirty window lattices, lampshades and corners on the outer walls with the elbow brush 3. In places that are difficult to clean such as the corners on the ceiling, the elbow brush 3 can be properly extended, for example the middle pipe 11 and straight pipe 12 can be used as an extension pipe between the elbow brush 3 and the air outlet 95.

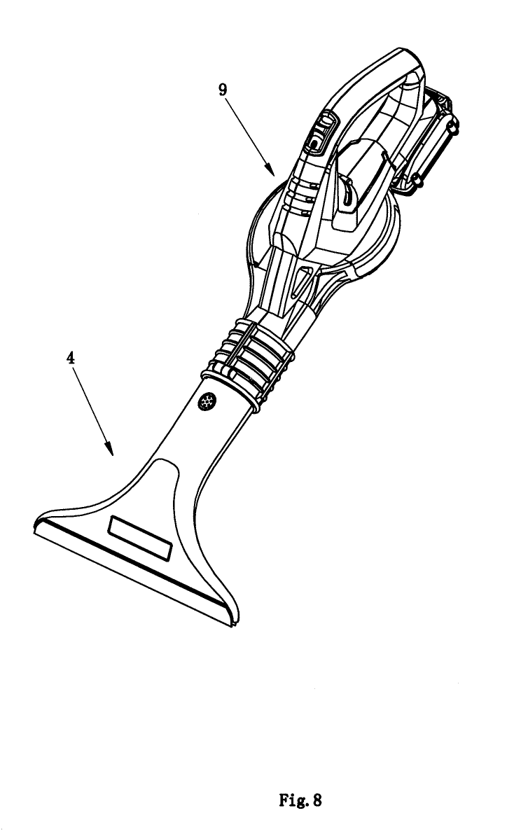

As shown in FIG. 3d and FIG. 8, the blowing accessories comprise a flat brush 4 comprising a longitudinal air inlet nozzle 41 and an air outlet nozzle 42 forming a certain bent angle relative to the air inlet nozzle 41. To control the air loss when the air passes from the air inlet nozzle 41 to the air outlet nozzle 42, the air inlet nozzle 41 and the air outlet nozzle 42 form an angel. In this embodiment, the angle is 95°˜165°. The air outlet nozzle 42 has a narrow outlet 421 extending perpendicularly to the air inlet nozzle 41 and has a certain length of between 100 mm and 400 mm. After being mounted on the blower 100, the flat brush 4 is capable of guiding the air from the air outlet 95 to the narrow outlet 421, so that the air acts on a narrow and concentrated area and blows the water membrane from the plane conveniently. To strengthen the scrapping effect of the flat brush 4, in this embodiment, the air outlet nozzle 42 is provided with a first pad and a second pad mounted relative to the first one. The first pad and the second pad both have a piece of rubber 422 which is a long strip matched with the first pad or the second pad in shape and wider than the first pad or the second pad. The rubber 422 extends out of the narrow outlet 421, so that the air is accumulated between the two pieces of rubber 422, thus avoiding scratching the object surface and also improving the blowing efficiency. The flat brush 4 connected to the air outlet 95 of the blower 100 can not only easily clean vehicle surfaces, but also quickly blow and dry water marks from the tabletops of glass window, glass door, tea table and sink after they were cleaned with water.

In this embodiment, the air inlet nozzle 41 of the flat brush 4 is made of a kind of rigid material, for example plastic, and matched with the air outlet 95 of the housing 9 in shape and dimension. The flat brush 4 can be directly coupled to the air outlet 95, so that the user can work conveniently with only one hand. Of course, the present invention is not limited to this. At places needing extension or turning, a coupling unit such as a hose or an extension pipe can be connected between the flat brush 4 and the air outlet 95.

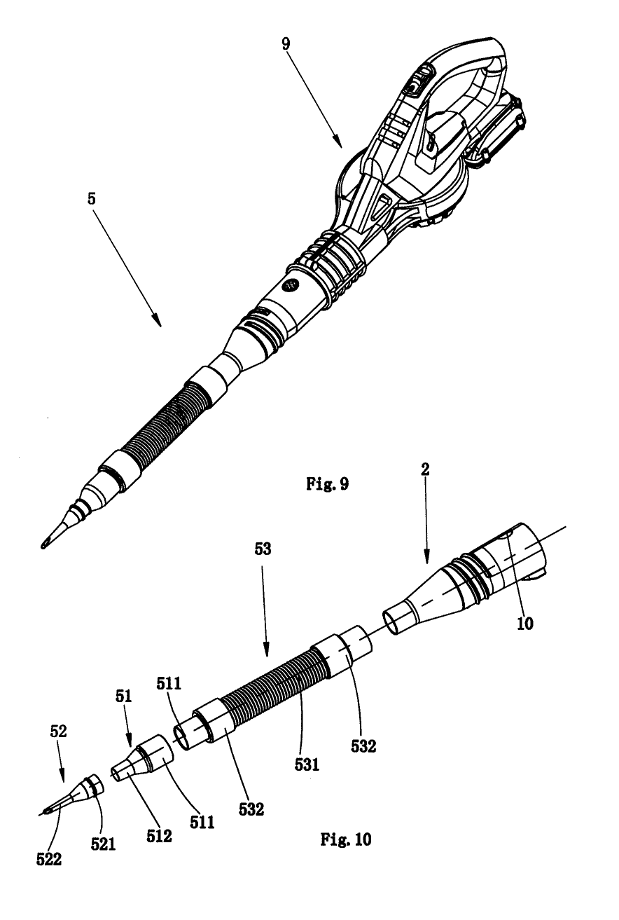

As shown in FIG. 3e, FIG. 9 and FIG. 10, the blowing accessories also comprise an inflating accessory 5. The inflating accessory 5 is comprised of at least one nozzle. In the embodiment shown, two nozzles (a first nozzle 51 and a second nozzle 52) are provided. The nozzle (51, 52) has a joint end (511, 521) and a free end (512, 522), the blowing opening of the nozzle (51, 52) is formed on the free end (512, 522) and the joint end (511, 521) has an inner dimension much bigger than the free end (512, 522). In this embodiment, the free end (512, 522) has an inner dimension of no more than 20 mm. The inner dimension reduces dramatically from the air outlet 95 to the nozzle (51, 52), thus increasing the pressure and the speed of air quickly and obviously, so that the blower 100 connected with the nozzle can be used to inflate. The free end of the first nozzle 51 namely the first free end 512 has an inner diameter of 10 mm˜20 mm, a ratio of a sectional area of the air outlet 95 to a sectional area of first free end 512 is between 20˜100, capable of inflating large-and-medium inflatable devices such as an air bed or a motorboat. Of course, other than for inflation, the first nozzle 51 can also act as a blowing nozzle to clean relatively small objects. The free end of the second nozzle 52 namely the second free end 522 has an inner diameter of 3 mm˜10 mm, a ratio of a sectional area of the air outlet 95 to a sectional area of the second free end 522 is between 100˜500. In this embodiment, the end face of the second free end 522 is an inclined plane forming an included angle of 15°˜80° relative to the longitudinal axis of the second nozzle 52. The second nozzle 52 may be used to inflate a small inflatable tool such as a swim ring or an inflatable ball. To fully make use of the existing devices so as to control manufacturing cost, in this embodiment, the second nozzle 52 can be detachably connected to the first nozzle 51, meaning that the first nozzle 51 acts as a coupling unit to provide size transition from the air outlet 95 to the joint end of the second nozzle 52 namely the second joint end 521 when the second nozzle 52 is used. Of course, in other embodiments, the second joint end 521 may be set to be consistent with the first joint end 511 in size, so that the two nozzles (51, 52) can work independently.

The first nozzle 51 may be configured in a way that the size of the first joint end 511 is approximately equivalent to that of the air outlet 95 so as to be directly coupled to the air outlet 95, or indirectly coupled to the air outlet 95 through another coupling unit. In this embodiment, the first joint end 511 is not big enough to be directly coupled to the air outlet 95. This means that a coupling unit with one end connected to the air outlet 95 and the other end connected to the first joint end 511 is required. Furthermore, to fully use the existing tools and realize more functions with fewer tools, the mentioned short tube 2 may act as the coupling unit, meaning the short tube 2 can be used not only as an independent blowing accessory, but also a coupling part to provide size transition from the air outlet 95 to the first joint end.

To expand the application scope of the nozzles (51, 52) and improve the accessibility of the nozzles (51, 52), in this embodiment, the inflating accessory 5 may also be comprised of a flexible tube assembly 53. The flexible tube assembly 53 comprises a flexible tube 531 and flexible joint ends 532 mounted at the two ends of the flexible tube 531. The flexible tube 531 and the flexible joint ends 532 at the two ends can be permanently or detachably connected. The flexible joint end 532 at one end is approximately equivalent to the first joint end 511 in dimension and the first nozzle 51 can be sleeved on the flexible joint end 532. The flexible joint end 532 at another end is approximately equivalent to the small end 22 of the short tube 2 in dimension to facilitate the first nozzle 51 coupling through the short tube 2. Namely the flexible tube assembly 53 can be detachably connected between the first joint end 511 and the short tube 2, while the second nozzle 52 is mounted to the first nozzle 51 if needed. In a word, the blower 100 can inflate the inflatable devices with the equipped first nozzle 51 and second nozzle 52, and the flexible tube assembly 53 is configured to expand the application scope of the nozzles. The blower 100 and the inflating accessory 5 are combined such that the user can explore new interests other than completing routine household cleaning work.

In addition, the flexible tube assembly 5 is configured as a standard unit, except for its use in above-mentioned inflating assembly 5, it can also facilitate the extending and turning around for other nozzles, for example the second brush 61. Of course, because the flexible tube assembly 5 is hollow, the flexible joint end 532 can be used as its blowing opening. For example, when there is a need to clean some corner hard to reach, maybe the flexible tube assembly 5 connected to the short tube 2 is the best choice instead of the single short tube 2 or the normal blower 100 tube 98.

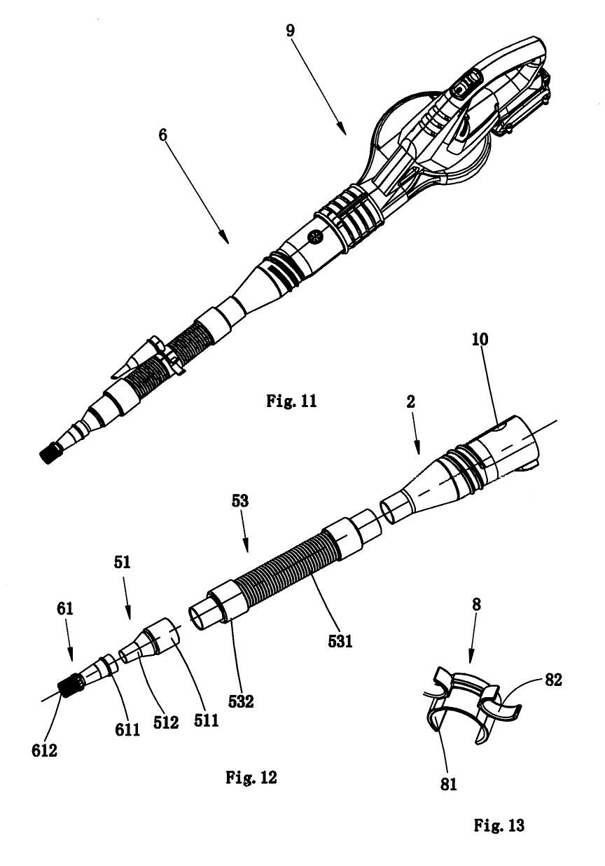

As shown in FIG. 3f, FIG. 11 and FIG. 12, the blowing accessories also comprise a second brush accessory 6. In this embodiment, the second brush accessory 6 comprises a second brush 61 for removing dust from slits. The second brush 61 can be applied to sites such as the keyboard, chassis, or instrument panels. The second brush 61 comprises a short nozzle 611 and a bristle head 612. The short nozzle 611 extends from the joint end to the free end. The blowing opening of the second brush 61 is formed on the free end. The bristle head 612 is mounted around the circumference of the blowing opening, and extends along the same direction as the short nozzle 611. In this embodiment, the cross section of the short nozzle 611 is round, and the inner diameter of the short nozzle 611 reduces gradually from the joint end to the free end. The inner diameter of the cross section of the free end is more than 3 mm, 5 mm-20 mm in this embodiment. Of course, the cross section of the short nozzle 611 may be round, oval, triangular, quadrangular, other polygonal or curved, but the maximum size of the free end does not exceed 20 mm. That's to say, the short nozzle 611 could be either of the mentioned short tube 2, first nozzle 51 and the second nozzle 52. A ratio of a sectional area of the air outlet 95 to a sectional area of the free end of the short nozzle 611 is between 4˜500. The bristle head 612 is configured in the same way as that of the bristles 32 of the elbow brush 3. The bristle head 612 may be continuously mounted around the outer surface of the free end in a circle, or uniformly embedded in the hole on the pipe wall at the free end. In this embodiment, because of the small free end, the second brush 61 blows high-speed air in a concentrated way. The bristle head 612 mounted at the front end of the second brush 61 can be used for sweeping and the blower 100 with the second brush 61 can be used to effectively blow the dust from the small slits.

The joint end of the second brush 61 can be configured to be equivalent to the air outlet 95 in its inner diameter. In this way, the second brush 61 can be directly coupled to the air outlet 95. The joint end of the second brush 61 can also be configured to be equivalent to the first joint end 511 in diameter, so that the second brush 61 can be coupled to the air outlet 95 through the short tube 2. In this embodiment, the joint end of the second brush 61 is approximately equivalent to the second joint end 521 in its inner diameter, so that the connection mode of the second brush 61 is the same as that of the second nozzle 52, namely requiring a coupling unit through the first nozzle 51 and the short tube 2.

Some objects are located at difficult places and can be hard to clean with the blower 100 equipped with the second brush 61, so the second brush 61 also has a flexible tube assembly 53 capable of extending and turning around. The structure and configuration of the flexible tube assembly 53 is preferably, but not necessarily, identical to that of the flexible tube assembly 53 in the inflating accessory 5. That is, the flexible tube assembly 53 arranged between the first nozzle 51 and the short tube 2 can be applied both to inflation and small objects sweeping occasions.

In the particular embodiments that use either the second nozzle 52 or the second brush 61, the short tube 2 and the first nozzle 51 are required. In addition, to ensure convenient operation and broader application, the flexible tube assembly 53 is a preferred part. However, the second nozzle 52 and the second brush 61 are idle when the user uses the first nozzle 51 for inflation. As mentioned above, the second nozzle 52 and the second brush 61 are both small accessories and can be dismantled from the first nozzle 51 when not in use so that they are easy to be lost. To avoid loss, this embodiment provides a clamp 8 for the second nozzle 52 and the second brush 61. As shown in FIG. 13, the clamp 8 comprises a first opening 81 and two small second openings 82. The clamp 8 is made of a plastic material and allows certain elastic deformation. In this embodiment, each second opening 82 is a circular arc-shape and has a radius approximately equivalent to the outer diameter of the second brush 61 or the second nozzle 52 and therefore you can clamp the second brush 61 or the second nozzle 52. The first opening 81 is also a circular arc-shape and has a radius equivalent to the diameter of the flexible tube 531 and therefore the clamp 8 can be accommodated with the second brush 61 and (or) the second nozzle 52 on the flexible tube 531. Of course, the shapes of the first opening 81 and the second openings 82 are not limited to a circular arc, and the first opening 81 is not limited to be fixed on the flexible tube 531, but can also be coupled to the flexible joint end 532, the short tube 2 or other parts such as the handle 92 on the housing 9 of the blower 100. It should be noted that the present invention may also comprise more than two second openings 82 to attach more accessories.

The above blowing accessories are all connected to the air outlet 95 of the blower 100 directly or indirectly through the coupling unit so as to blow fallen leaves from the higher gutters and water marks from glass, sweep the reachable platform or window lattices and slits in the instrument panel and drawers, and inflate some common devices. Of course, the blowing accessories may also comprise other functional accessories not listed above. All accessories figured out by those skilled in the art to blow through the air outlet 95 can be used as blowing accessories of the present invention coupled to the air outlet 95. To facilitate use of each of the blowing accessories, the joint of the air outlet 95 and each of the blowing accessories is a detachable connecting structure. In this embodiment, the air outlet 95 adopts the same structure to connect the short tube 2, the middle pipe 11, the elbow brush 3 and the flat brush 4. The air outlet 95 is provided with at least one elastic button 950, while the joint end of either of the short tube 2, the middle pipe 11, the elbow brush 3 and the flat brush 4 is provided with at least one orifice 10 matched with the button 950 in size, shape and position. During installation, the short tube 2, the middle pipe 11, the elbow brush 3 or the flat brush 4 is coupled to the air outlet 95, and then the elastic button 950 is coupled with the orifice 10 in a detachable way. Of course, the positions of the elastic button 950 and the orifice 10 can be exchanged, and the detachable fit between the above accessories and the air outlet 95 may be in a range of modes, such as a fit between a rigid bump and an L-shaped groove and threaded fit. Other common connections may be known in the art.

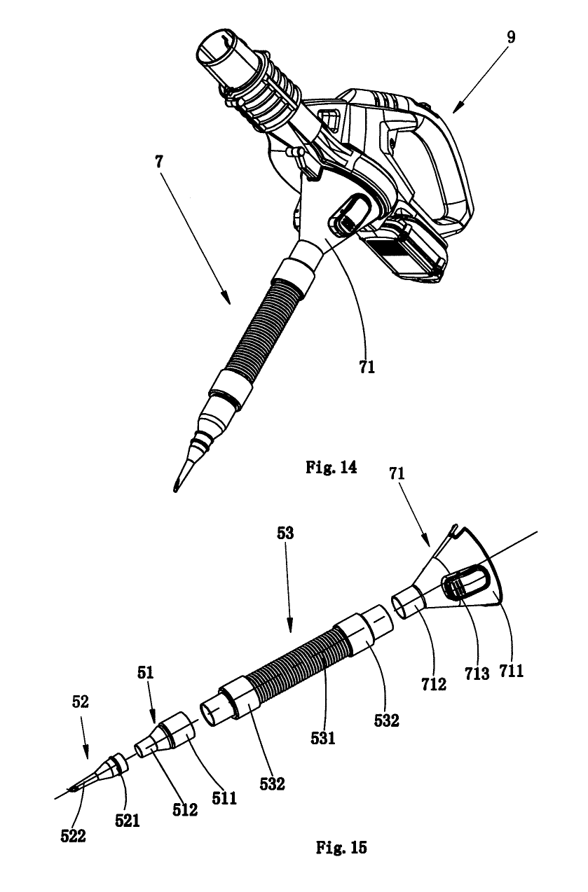

As shown in FIG. 14 and FIG. 15, the blower 100 can also comprise a deflating accessory 7 that can be connected to the air inlet 94 to deflate air through the air suction action of the air inlet 94. In this embodiment, the deflating accessory 7 comprises a deflating funnel 71 in a longitudinal connection with a uniform wall and a deflating nozzle. The deflating funnel 71 has a big opening 711 with a big inner diameter and a small opening 712 with a small inner diameter, where the big opening 711 is used for covering and communicating with the air inlet 94 to prevent air leakage during deflating. The small opening 712 is used for connecting and communicating with the deflating nozzle. The deflating nozzle has a deflation opening at one end away from the deflating funnel 71. The inner diameter of the deflation opening is 3 mm˜20 mm.

As shown in FIG. 1, FIG. 14, and FIG. 15, the air inlet 94 of the blower 100 is usually fixed and provided with an air inlet grill 96 shaped as a reverse pyramid. The air inlet grill 96 is provided with a plurality of grids 960 to prevent hands or items from injury or damage because of contact with the rotating fan or the motor driving the fan. A detachable interlocking structure is arranged between the big opening 711 of the deflating funnel 71 and the air inlet grill 96. In this embodiment, the outer circumference of the big opening 711 is symmetrically provided with two pushing blocks 713. The two pushing blocks 713 are respectively connected to the hooks (not shown in the figure) in the deflating funnel 71. The hooks can be matched with the grids 960 on the air inlet grill 96 to make the connection between the deflating funnel 71 and the air inlet grill 96. When the deflating funnel 71 is required to be mounted, the hooks are engaged with the grids 960. When the deflating funnel 71 is required to be dismantled, the hooks are disengaged from the grids 960 by pressing the pushing button 713 with the user's thumb and forefinger. Of course, the number of the pushing blocks 713 is not limited to two, and the interlocking structure mentioned above is only one form of connection between the deflating funnel 71 and the air inlet grill 96, including some commonly understand structures known in the art.

In this embodiment, the deflating nozzle has features identical to those of the mentioned nozzles (51, 52). The nozzles (51, 52) acting as an inflating accessory 5 can also be used for pumping as long as the nozzles are shifted from a connection with the air outlet 95 into a connection with the air inlet 94. Corresponding to the inflation operation, the deflating nozzle also comprises a first nozzle 51 and a second nozzle 52. The first nozzle 51 can be directly connected to the small opening 712 of the deflating funnel 71, and second nozzle 52 is coupled with the first nozzle 51. The specific structure and coupling of the first nozzle 51 and the second nozzle 52 have been described in detail above.

Like the inflation operation and cleaning of the slits and instrument panel, the user may not be able to directly operate the blower 100 equipped with the deflating accessory 7 in some narrow or shaded spaces when pumping is required. Therefore, the deflating accessory 7 also can have a flexible tube assembly 53 connected between the deflating funnel 71 and the first nozzle 51. In this embodiment, the flexible tube 531 in the deflating accessory 7 is consistent with the above-mentioned flexible tube assembly 53, namely using the same flexible tube assembly 53 with inflating accessory 5 and the second brush accessory 6.

When the above-mentioned deflating accessory 7 is used for pumping air, the rotating fan quickly reduces the air pressure in the air channel formed by the inner walls of the deflating funnel 71 and the deflating nozzle, or the combination of the former two and the flexible tube assembly 53. The air continuously flows out from the inflated devices to be deflated and then into the air channel of the blower 100, thus completing the whole deflation process. The blower 100 equipped with the deflating accessory 7 can pump a variety of inflatable devices such as the mentioned air bed, motorboat, swim ring, inflatable balls, etc. The deflating accessory 7 can be used to pump out air when those devices are required to be put away after use, thus reducing the storage space.

Except for the deflating accessory 7, the air inlet 94 can also be connected to other air suction accessories, such as the second brush accessory 6. Likewise, the deflating funnel 71 can act as a coupling unit to connect the combination of the flexible tube assembly 53, the first nozzle 51 and the bristles 32 to the air inlet 94. Thus, the blower 100 can be used to suck dust. Of course, when the suction or blower device of the present invention is a suction assembly, the air inlet 94 can be connected to more air suction accessories.

The definitions of the above members are not limited to structures or shapes mentioned in the above embodiments, and those skilled in the art may make simple substitutes or additional uses. All modifications and substitutes made on the basis of the present invention that come within the scope or spirit of the attached claims shall fall within the protection and scope of the present invention.

What is claimed is:

1. A handheld blower having a suction function, comprising:
a housing having an air inlet and an air outlet, wherein the air inlet and the air outlet are integrally formed on the housing, and wherein the air inlet and the air outlet have different structures and are configured to directly couple to different accessories;
a motor accommodated in the housing;
a fan driven by the motor; and
a plurality of blowing accessories adapted to be connected to the air outlet, wherein the plurality of blowing accessories further comprises (a) at least three longitudinal blower tubes, wherein a first and second blower tube of said at least three longitudinal blower tubes includes a mating rotational connection therebetween such that said first blower tube can rotate 360 degrees relative to the second blower tube;
(b) an elbow brush having a blower nozzle with bristles and the blower nozzle being angular to the air outlet;
(c) a flat brush having a narrow outlet extending perpendicularly to the air outlet; and
(d) a gutter cleaning pipe having a straight pipe and an elbow pipe connected to the straight pipe,
and wherein each blowing accessory of the plurality of blowing accessories is interchangeable with each other blowing accessory of the plurality of blowing accessories, and wherein each blowing accessory of the plurality of blowing accessories is directly connectable to the air outlet of the housing, and wherein the housing is configured to directly couple to one type of the plurality of types of blowing accessories at the air outlet at a given time.

2. The handheld blower according to claim 1, wherein one of said at least three blower tubes has a blowing opening and a cross-sectional area of the air outlet, wherein a ratio of the cross-sectional area of the air outlet to a cross-sectional area of the blowing opening is between 4-500.

3. The handheld blower according to claim 2, wherein one of the blower tubes comprises a short tube with a blowing opening, and a ratio of a cross-sectional area of the air outlet to a cross-sectional area of the blowing opening is between 4-20, and the short tube has a length no more than 200 mm.

4. The handheld blower according to claim 3, wherein the short tube has a big end and a small end, the blowing opening is formed on the small end, and the big end is adapted to be connected to the air outlet directly.

5. The handheld blower according to claim 4, wherein the blower tube further comprises at least one of a first nozzle and a second nozzle, the first nozzle having a first blower opening and the second nozzle having a second blower opening, a ratio of a cross-sectional area of the air outlet to a cross-sectional area of the first blowing opening is between 20-100, and a ratio of a cross-sectional area of the air outlet to a cross-sectional area of the second blowing opening is between 100-500.

6. The handheld blower according to claim 5, wherein the first nozzle comprises a first joint end and a first free end, the first blowing opening is formed on the first free end, and the first joint end is detachably connected to the small end.

7. The handheld blower according to claim 4, wherein the plurality of blowing accessories further comprises a flexible tube assembly having a flexible tube with two flexible jointed ends formed thereon respectively, and the flexible tube assembly is detachably connected to the small end.

8. The handheld blower according to claim 5, wherein the first nozzle comprises a first joint end and a first free end, the first blowing opening is formed on the first free end, the second nozzle comprises a second joint end and a second free end, the second blowing opening is formed on the second free end, and the second joint end is adapted to be connected on the first free end.

9. The handheld blower according to claim 6, wherein the plurality of blowing accessories further comprises a flexible tube assembly having a flexible tube with two flexible jointed ends formed thereon respectively, the flexible tube assembly is detachably connected between the small end and the first jointed end, the second nozzle comprises a second joint end and a second free end, the second blowing opening is formed on the second free end, and the second joint end is adapt to be connected on the first free end.

10. The handheld blower according to claim 2, wherein the blower tube further comprises a bristle head mounted around the circumference of the blowing opening, the bristle head extending along the same direction as a longitudinal extending direction of the blower tube.

11. The handheld blower according to claim 1, wherein the elbow brush comprises a jointed end being configured to be connected with the air outlet and a fixed end being configured to be angularly bent and communicated to the jointed end, the bristles mounted around the circumference of the fixed end and extending along the same direction as a longitudinal extending direction of the fixed end.

12. The handheld blower according to claim 11, wherein the bristles have a certain length of no more than 40 mm.

13. The handheld blower according to claim 1, wherein the flat brush comprises an air inlet nozzle extending longitudinally and an air outlet nozzle being angular to the air inlet nozzle, the narrow outlet is formed on a free end of the air outlet nozzle.

14. The handheld blower according to claim 13, wherein the air outlet nozzle comprises a first pad and a second pad opposite the first pad, the first pad and the second pad both have a piece of rubber fixed thereon respectively.

15. The handheld blower according to claim 1, wherein the gutter cleaning pipe is 360° rotatably connected to the air outlet.

16. The handheld blower according to claim 1, wherein the first blower tube further comprises a middle pipe having a first end detachably connected to the air outlet and a free end opposite said first end, and wherein the second blower tube further comprises a straight pipe having a first end and a second end.

17. The handheld blower according to claim 16, wherein said mating rotational connection between said middle pipe and said straight pipe further comprises a bump arranged on the free end of the middle pipe, a circumferential groove arranged on the first end of the straight pipe, and an axial guiding groove on the first end of the straight pipe, wherein the axial guiding groove guides the bump to enter and slide in the circumferential groove.

18. The handheld blower according to claim 17, wherein the bump has an interference fit against the circumferential groove.

19. The handheld blower according to claim 1, wherein the straight pipe comprises a set of small pipes coupled to one another through a threaded fit.

20. The handheld blower according to claim 19, wherein each small pipe has a coupling portion supporting at least two heads of thread.

21-31. (canceled)
